(19) United States
(12) Patent Application Publication
(10) Pub. No.: US 2003/0041107 A1
(43) Pub. Date: Feb. 27, 2003

(54) METHOD AND APPARATUS FOR COMMUNITY NETWORK COMMUNICATION

(76) Inventors: DOUGLAS O. BLATTNER, LAS VEGAS, NV (US); MEERA M. BLATTNER, SAN JOSE, CA (US); MINAO KAMEGAI, SAN JOSE, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/360,282

(22) Filed: Jul. 22, 1999

(51) Int. Cl. G06F 15/16

(52) U.S. Cl. 709/204

(57) ABSTRACT

A community network includes a central server and member systems. The member systems negotiate with one another to establish agreements with regards to the distribution of messages between the member systems. The central server transmits messages that are defined in the agreements between the member systems in response to a message from a member system that is part to the particular agreement. The member systems include home automation modules that can use the central server to transmit messages from one home automation module to another once an agreement is established between the two member systems.

### BACKGROUND OF THE INVENTION

1. Field of the Invention

The present invention relates to the field of computer networks. Particularly, the present invention relates to software systems and computer networks for facilitating communication between members of a computer network.

2. Description of the Related Art

With modem times, as the pace of life has increased, urban living has largely lost its sense of community. Typically, people living in small towns knew their neighbors, who often provided aid in various forms such as providing daily assistance, emergency assistance or even emotional support. The front porch was a place to relax and socialize with neighbors. Modem times have brought homes that turn their back to neighbors and pull inward. The realities of modem life often require husband and wife to work, leaving little time to meet one's neighbors.

Some electronic systems have become available to control home operation such that home occupants can control their homes, even remotely, without reliance on neighbors. Such systems are generally referred to as “home automation systems.”

### SUMMARY OF THE INVENTION

In accordance with the present invention, the traditional advantages of a community can be restored and some non-traditional advantages can be realized by using a computer network. Not only can homes of friends and neighbors be linked, but stores and service providers can also be linked in the electronic community. A central community system can provide such services to community members (homes, offices, retail establishments, and other businesses) without unnecessary redundancy created by installing systems on an individual basis. Some examples of the functions that the central community system can provide are:

1. Neighborhood watch—notification of an unauthorized home entry; suspicious behavior near a home.

2. Health and safety monitoring—notification of traffic hazards, detours, and emergencies to paramedics, police, fire departments.

3. Central sensor information—ongoing reports of weather, temperature, barometric data, light conditions, etc.

4. Messaging—maintaining a community intranet with fast network connections for home entertainment and Internet communication.

5. Applications-on-demand—providing spreadsheets, banking, etc.

6. Home automation—supplying application software, service and support staff for the home automation system.

7. Retail services—placing orders with retail establishments and checking prices before purchases are made.

If standalone systems for such services were acquired by individuals in a community, the cost would be quite high. Integrating functionalities and services in a central community system provides these services for a reduced cost. The present invention provides a system that makes use of intelligent software agents by which individual subscribers can communicate with the central system to perform a wide range of functionalities and services.

This invention provides an electronic community for members, including homes, offices, retail establishments, service providers, and emergency services. The centralized system of the present invention greatly reduces the cost of acquiring and maintaining the equipment for these services and functions for individual members and alleviates unnecessary redundancy. The system employs a message brokering mechanism to bring together member systems. Thus, the member systems can communicate with one another in accordance with earlier decided criteria. The central server of the community network provides members with an interface and a system for negotiating for the transmission of data from one community member system to another.

In accordance with the present invention, the functions and services in the central community system which link together individual community member systems and service agents are integrated. According to one embodiment of the invention, the individual community member systems use secure, authenticated communication which is supported and arbitrated by a trusted third party, the central server. These individual community member systems may be, but are not limited to, home control systems, office control systems, public utility and service systems, and electronic objects of all kinds throughout a community.

### BRIEF DESCRIPTION OF THE DRAWINGS

FIG. 1 illustrates an arrangement of a community network in accordance with an embodiment of the present invention.

FIG. 2A illustrates the general steps taken by a member system in proposing a message exchange between the member system and a target member system in one embodiment of the present invention;

FIG. 2B illustrates the general steps in one embodiment of the present invention performed to process an offer for a message exchange;

FIG. 3 illustrates a login screen of a message brokering server interface;

FIG. 4A illustrates a message exchange offer creation screen;

FIG. 4B illustrates a target member selection screen;

FIG. 5 illustrates a message exchange offer lookup screen;

FIG. 6A illustrates a message exchange offer management screen;

FIG. 6B illustrates a second embodiment of a message exchange management screen;

FIG. 7 illustrates a message request screen;

FIG. 8 illustrates a message publication request acceptance screen;

FIG. 9 is a block diagram of one embodiment of the software architecture of the Satellite Control Systems including data flow paths within the Community Connector, and among a Home Automation Control System, a Community Connector and an Operating System.

FIG. 10 is a block diagram illustrating connectivity and data flow paths of the Central Community System in one embodiment of the present invention.

FIG. 11 illustrates an example Message Exchange Look-up Table.

FIG. 12 illustrates an alternative arrangement of the modules of a member system;

FIG. 13 illustrates the steps taken by a member system in providing events to the SynapServer and receiving events from the SynapServer in accordance with one embodiment of the present invention;

FIG. 14 illustrates the steps taken by the SynapServer in processing event data received from member systems; and

FIG. 15 illustrates steps performed by a target member or object in receiving and responding to event-based data.

### DETAILED DESCRIPTION OF THE PREFERRED EMBODIMENT

A computer network in accordance with the present invention will now be described with reference to an embodiment of a computer network and an arrangement with member systems and a central server. The operation from the point of view of a user of the system will first be described with reference to screens comprising a user interface of a computer network in accordance with an embodiment of the present invention. The structure of a computer network will then be described with reference to figures illustrating one arrangement of a central server and member systems in a network. Finally, the operation of the modules of the computer network of the present invention will be described with reference to illustrations of the arrangement and operation of those modules.

I. Definitions Applicable to a Preferred Embodiment of the Present Invention

1. Exchange Contract—a data distribution agreement between at least two member systems. The exchange contract authorizes the exchange of data between an offering member system and an accepting member system.

2. Object—a device that is associated with a system. Any module or component that is capable of providing or responding to data, including events or assertions, over the network may be considered an object. Examples include home automation systems and their subsystems such as alarms, lights, appliances, swimming pool pumps and heaters, sprinklers, garage doors and electricity, gas and water use meters, hospital systems, law enforcement systems, fire department systems, telephone systems, television and cable systems, data communication systems, water and sewer systems, gas and electric systems, security gates, and street lights and lamp posts.

3. Property—an identifier that is part of an object. A property is used to identify data that is associated with the object.

4. Event—data generated by a change in state of an object.

5. Message—any transmission of data including an exchange contract offer, an exchange contract acceptance, an e-mail notification, a stream of data, etc.

6. Bulletin Item—a term used to refer to a set of properties for an object.

7. CivicServer—a server that facilitates the negotiation of exchange contracts. The CivicServer allows member systems and objects to create and manage exchange contracts.

8. SynapServer—a server that facilitates the transmission of data between member systems and objects in accordance with exchange contracts.

9. Member Systems—individual community members, including, but not limited to, Satellite Control Systems.

10. Community Connector—an element of a member system, which facilitates a secure authenticated communication between the member system and the SynapServer.

11. Information Provider—a kind of member system supplying data made available to member systems.

12. Information Consumer—a kind of member system requesting data from member systems.

13. Service Agent—a kind of member system that responds to data from a member system to provide services.

14. Module—As used herein, the word module, whether in upper or lower case letters, refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays. The modules described herein are preferably implemented as software modules, but could be represented in hardware or firmware.

II. Operation

The operation of the present invention will now be described with reference to an example scenario of a user creating an offer for an exchange contract and a second user taking steps to accept an exchange contract. Additionally, the steps taken in accepting exchange contracts and offering exchange contracts to information suppliers and information providers, respectively, will be described.

The illustrated system facilitates the creation of exchange contracts that result in a mapping of an entire set of properties from a first object to a second object. Nonetheless, the illustrated system can be extended to a system that selectively maps properties of a first object to properties of a second object. The mapping of data from select properties can be accomplished by providing a further level of selection to a user that is generating an exchange contract offer as described below.

In coming years, increasing numbers of homes will have some form of intelligence such as that which is provided today by home automation systems. Therefore, there will be a need to broker communications between homes to allow the intelligence in the various homes to provide some collaborative value. For example, when an alarm system in one house is triggered, great value may be derived by transmitting a message to the four homes around the house plus notifying the central station. For various reasons and in response to a variety of events, vast arrays of objects may generate and respond to community conditions, whether intruder-based, media-based or health-related or based on weather patterns or other conditions.

The community network of the present invention is focused on physical communities. The description below is in the context of a master planned community. Nevertheless, the description is equally applicable to any community, which may be a virtual community.

As an illustration of the application of the system, consider a first home and a second home. Both homes have home information systems of some form. The community network provides a service to these systems by allowing the systems to communicate data between objects of the systems. For example, an alarm system may be an object of a home information system. The alarm system includes properties such as an “intruder” property. The “intruder” property may have a data value of “true” when an intruder is detected, and a data value of “false” otherwise. The owner of a first home may wish, if the alarm system in the first home goes off, to notify a second home, but not a third one. If a member wants the data from the alarm system to go to the homes on either side, the system can be used to facilitate the establishment of such agreement.

It is important to note that a negotiation takes place between the member systems and/or objects to obtain authorization. It is also important that a trusted third party arbitrates the negotiation because the third party may potentially have visibility into all member systems.

Two homes might be neighbors with automation systems capable of processing many types of events, but they may want to exchange and respond to only one key piece of data. For example, the two homes may only want to exchange a data value associated with an “intruder” signal, which may be generated when the alarm system of one of the homes is triggered.

The system of the present invention provides a network of individual community members and objects linked to neighbor members and objects and other community members and objects via the community network. After establishing agreements between members, the SynapServer provides data, not only to the appropriate service agents, but also to other member systems and objects, to bring an unprecedented and advantageous level of cooperation to and throughout the community.

For example, when a medical emergency is signaled by a community member, the response by the SynapServer may be to notify an appropriate emergency service, and simultaneously alert the community member's neighbors (who agreed to be so notified) to come to the aid of the member requesting help. The response time of the emergency service could be 10 to 15 minutes while the immediate neighbors can respond in one or two minutes. Under some circumstances, this may make the difference between life and death. Such a system expedites services and hence improves the quality of life in the community.

The community network can provide for an indirect mapping of properties such that data from a first kind of object can be used by a second kind of object. For example, when a member sees a prowler going into another member's house the member may want to turn the other member's lights on. If the second member has agreed that the first member is permitted to take this action, the lights can be turned on by delivering the appropriate data from the first member system. For example, the first member can have a control panel on the wall with a special button labeled “lights in second member house.” The button press provides a data value to the SynapServer that is transformed to a data value, which the SynapServer transmits to the second member system, that has the effect of turning the lights on in the second member home. As a second example, indirect mapping may be provided when data from a device such as a thermostat is converted from Fahrenheit to Celsius when it is transmitted to a target thermostat that used Celsius scale data.

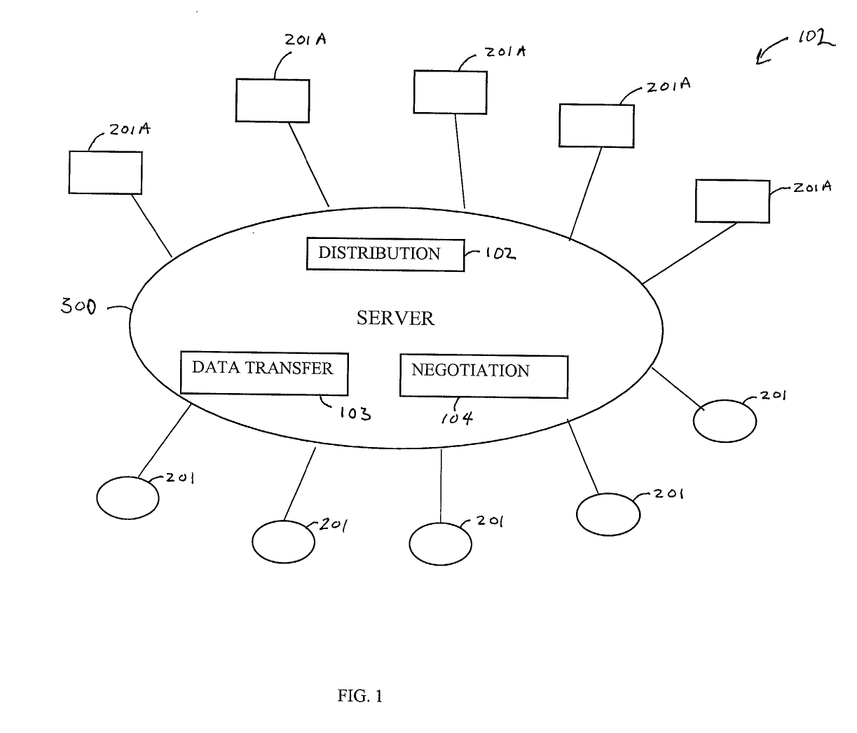

FIG. 1 illustrates a general block diagram of the community network 102, linking together, via a central server 300, a plurality of member systems 201, 201A which include individual community members 201 (home/office) as well as service agents, retail businesses, emergency services, and other objects 201A. The central server 300 includes a data transmission module 103, a negotiation module 104, and a distribution module 102.

The negotiation module 104 facilitates the negotiation of exchange contracts between member systems. The data transmission module 103 facilitates the transmission of data between member systems. The distribution module 102 is used to store exchange contract information. In a preferred embodiment, the negotiation module 104 is a CivicServer and the data transmission module 103 is a SynapServer which uses distribution data maintained by the distribution module 102. Data is transmitted through secure authenticated communication as described in greater detail below. The confidence and the trust in the SynapServer is a significant factor in acceptance of the system of the present invention on a large scale.

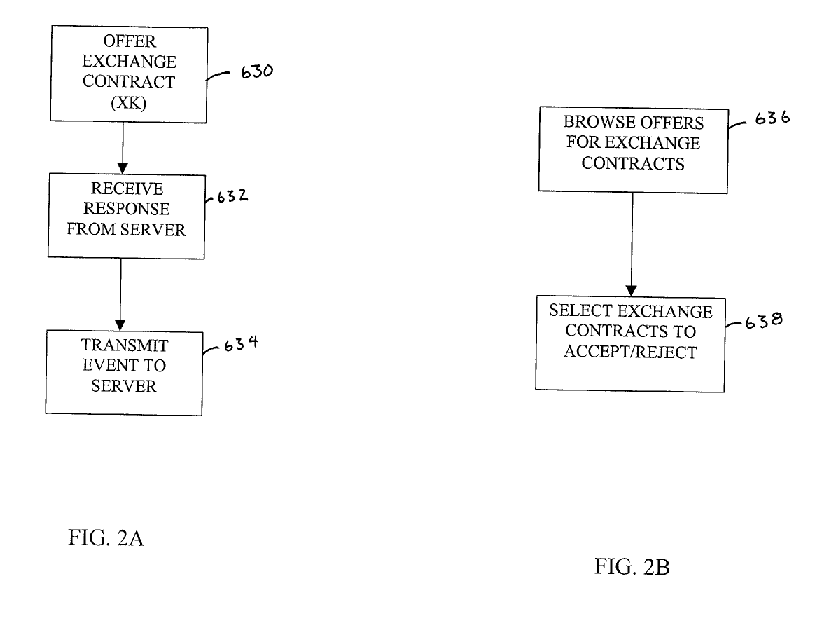

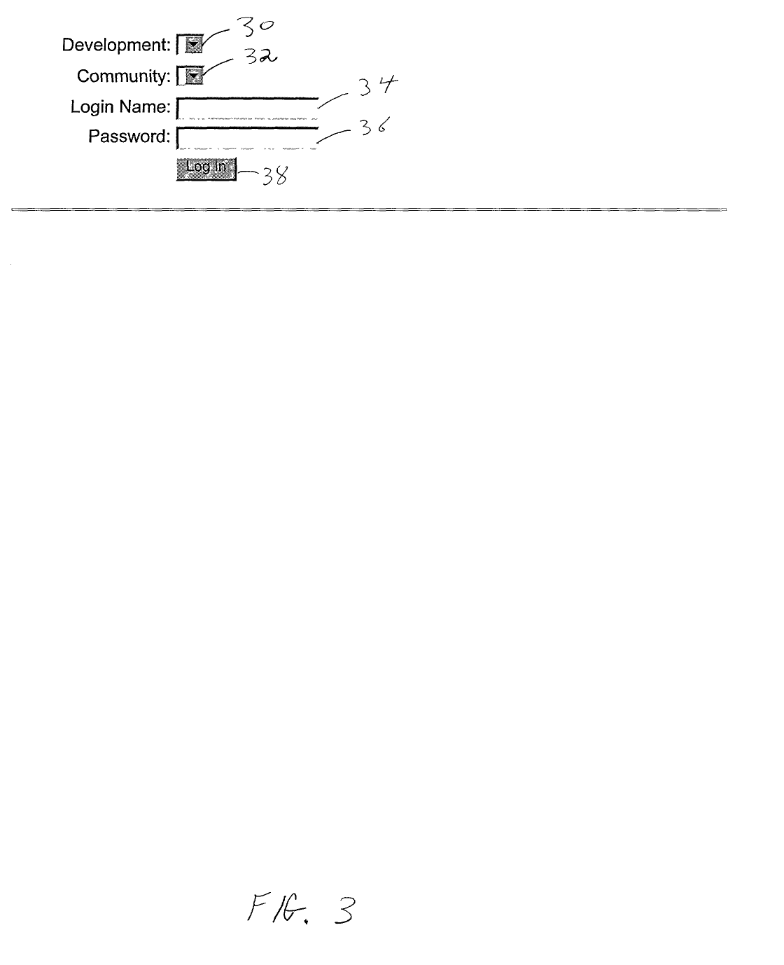

With the architecture of the system, each member system need only have confidence in the SynapServer and in its ability to accurately and reliably deliver messages to other users in a confidential manner. The central community system is designed to allow a designated user for a given member system to “publish” that certain object data is available and direct the data to a specific destination system or systems. The object data may correspond to an event or assertion representing a state of a member system, subsystem or object. The designated user (or an object itself) for the destination system must first “approve” the proposed transfer before the SynapServer actually transfers data between the source and destination member systems. Any party to a communication may prevent the transfer by “revoking” permission to accept particular messages. The approval of the designated user of the target system creates an exchange contract. The exchange contract is created when an offer from one member is approved, or accepted, by the target member or proposed destination system. The process of creating offers for exchange contracts and updating the status of pending offers is illustrated in FIGS. 2A and 2B.

In brief, the process starts when a member logs into a main system over a network, such as the Internet, and identifies himself or herself with a user name and password. The system maintains a database corresponding to the objects and events that are available in the user's local environment. The user is provided with a list of objects. It will be appreciated that, while, for simplicity of explanation, the embodiments discussed below identify objects that are selectable by a user, the present invention contemplates that users will select not only objects, but also properties of objects and potentially data values or ranges of properties. For example, a user may select a thermostat object and base an exchange contract on an event associated with the thermostat object. However, the present invention also contemplates that a user may alternatively base an exchange contract on a single property of the thermostat object such as a temperature property or a fan motor property or a cooling set point property. Furthermore, the present invention further contemplates that a user may base an exchange contract on particular data values or ranges associated with any one of those properties.

The user then selects one of the objects, and selects community members from a list of community members. The system then notifies the identified community members of a pending offer of an exchange contract. When the identified members receive the notification, they log onto the system and either accept or reject the proposed exchange contract. If the identified members accept the offer, an exchange contract has been made. The central system will thereafter, in a reliable, authenticated and secure manner, transmit the assertion or event to each identified member each time it is notified of the assertion or event by the user member's local system.

FIG. 2A illustrates the process of creating an offer for an exchange contract. In a first step 630, the user of the member system (“user”) first logs into a CivicServer to create an offer. The CivicServer facilitates negotiations of exchange contracts. The user directs the system to an offer creation page, which allows the user to create an offer for an exchange contract. The user selects an object which, from time-to-time, may generate an event in response to which data may advantageously be provided to target systems. The object is selected from a list of available objects which may, for example, correspond to event generating objects associated with the user's home automation system.

The user also selects a target member system to which an offer will be transmitted. Thus, in a next step 632, the CivicServer responsively provides information to the user corresponding to identities of other member users. The target member system is selected from a list of members. The member list can be provided, for example, by an expandable tree view such as that used for file management in the Windows operating system. The expandable tree view may include member systems that are sorted according to geographic location and/or arranged in a hierarchical manner such that, for example, all members in a certain state collapse to a single branch, and all members in a certain city collapse to a single branch.

Once a target member system is selected, the system prompts the member to enter a description for the object. In this manner, the recipients of the message are not provided with the direct object identifier, but are only provided with the description that the member desires to provide to the target members, a description which preferably describes the nature of the assertion offered. Masking the object identifier advantageously provides for a high level of member privacy.

When the user is satisfied with the selection made, then in a step 634, the event and member data are transmitted to the CivicServer. The process of creating the offer for the exchange contract is complete and notifications regarding the exchange contract offer are sent to each of the target systems. In one embodiment of the present invention, the CivicServer generates e-mail messages to notify target members. To do this, the CivicServer maintains a table associating e-mail addresses with member identification valves.

FIG. 2B illustrates the steps performed by a target member system to receive and respond to an offer for an exchange contract. In a first step 636, the target user views or browses the proposed exchange contracts by logging into the CivicServer.

In a next step 638, the target member selects one of possibly many pending exchange contract offers and decides whether to accept or reject the selected offer. In one embodiment, offers are time limited, wherein an offer expires a predetermined time after the offer was extended. When a target member rejects an offer, a message may be automatically sent to the proposing party, such as, for example, by e-mail, notifying the party that the offer has been rejected. When a target member accepts an offer, a message is advantageously automatically sent to the proposing party notifying the proposing party that the offer has been accepted. An accepted exchange contract offer creates a new exchange contract. The exchange contract information is sent from the CivicServer to the SynapServer. The SynapServer then facilitates the delivery of data between member systems in accordance with existing exchange contracts.

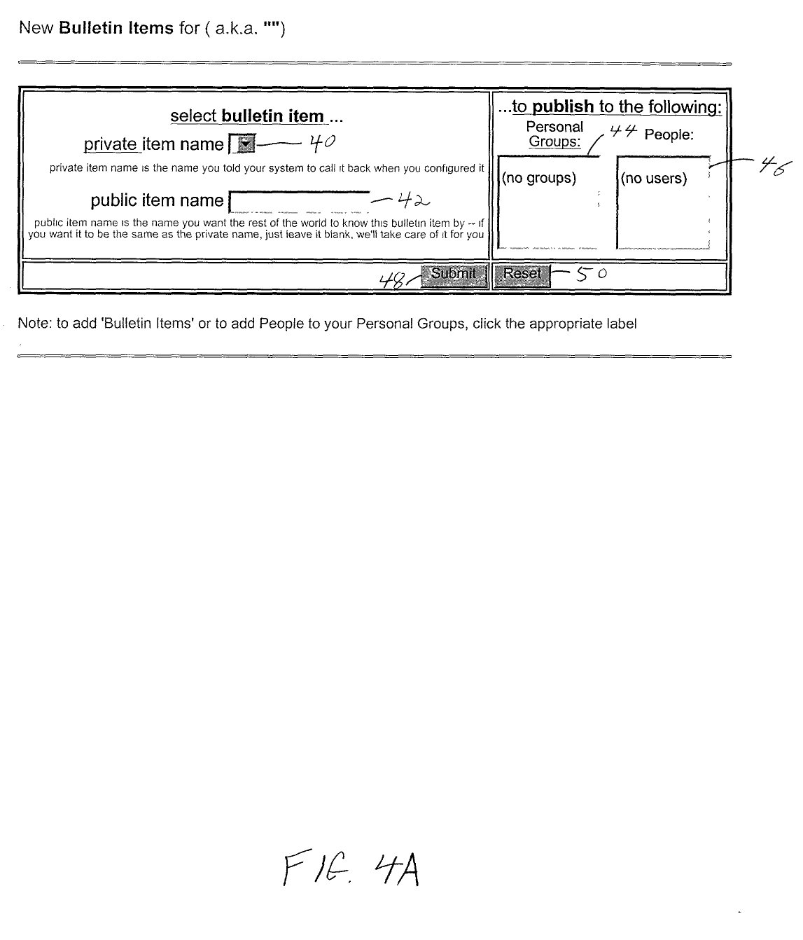

FIGS. 3-8 illustrate screens of an Internet-based implementation of a CivicServer. The CivicServer of FIGS. 3-8 is used to facilitate the negotiation of exchange contracts for linking objects of member systems. Nonetheless, the CivicServer can facilitate the negotiation of other kinds of exchange contracts such as those providing dynamic data from a property of a source object to a second property of a target object.

FIG. 3 illustrates a log-in screen of the CivicServer of the present invention. The CivicServer facilitates the creation of exchange contract offers and exchange contract management by users of the system. The login screen includes a dropdown box 30 for a development identification, a dropdown box 32 for a community identification, and a pair of entry boxes 34, 36 for a login name and a password, respectively. The user selects the proper development and community from the dropdown boxes. The user enters his login name and password and clicks on the login control button 38.

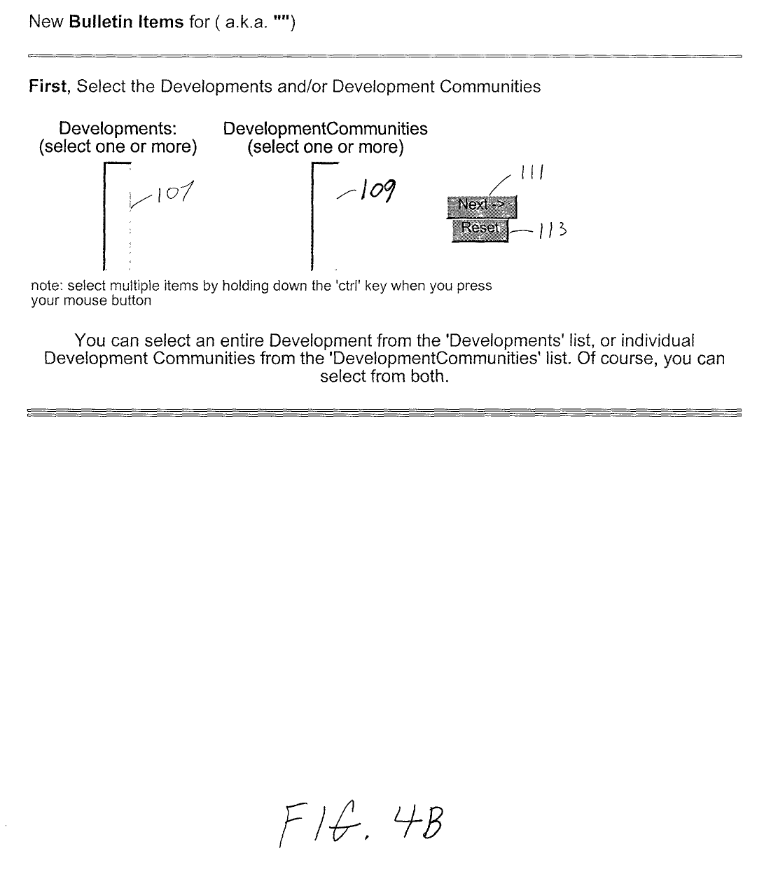

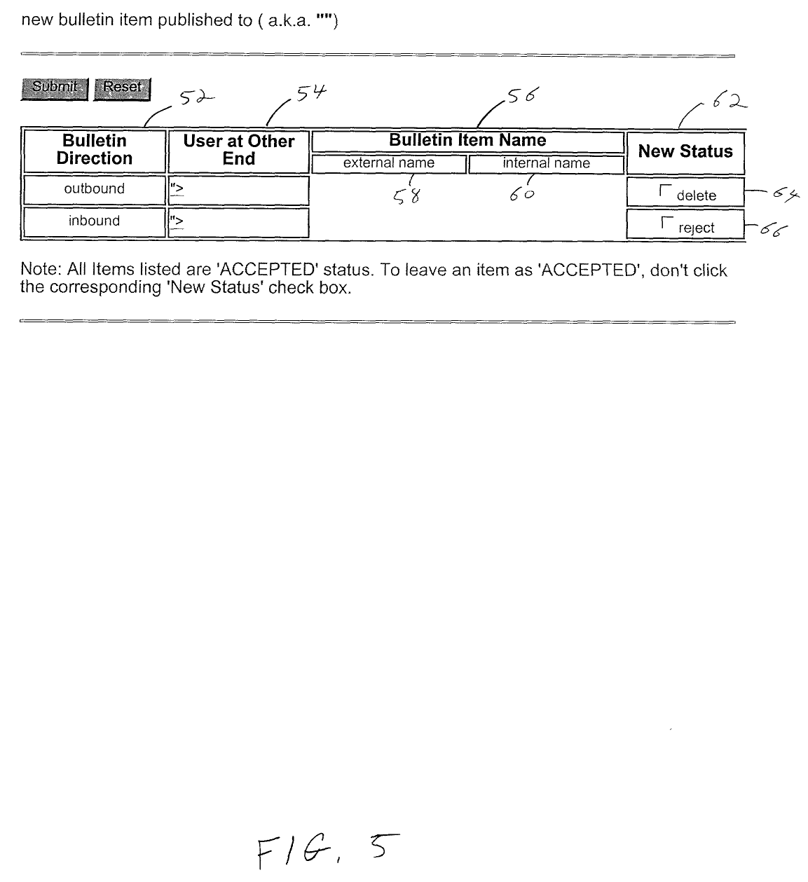

After the login procedure, the user is presented with a menu that includes several options. One of the options is to create a new exchange contract. The system first provides a user with a screen that is illustrated by FIG. 4A to create an exchange contract. The screen of FIG. 4A includes a first field for a bulletin item identification and a second field for a target identification. The bulletin item identification field includes a dropdown box 40 with event identifiers and a public item name entry box 42 to publicly identify the object that is selected from the dropdown box 40. The user uses the object dropdown box to select from the objects that are available on the user system such as, for example, the alarm system. The user enters the name for the object that the user wishes to provide in the exchange contract offer. The identity of the target member system to which the data is sent in response to the event is selected from either a personal group or a particular user identifier. The user clicks in the personal group box 44 to select a personal group that has been previously created. It should be noted that, when a personal group is selected, multiple exchange contracts are generated, one for each member in the group. The user can also click on a people box 46 to select individual members from a tree type selection interface that is provided by the system (not shown).

FIG. 4B illustrates a target member selection screen of the CivicServer. The target member selection screen includes a first selection box 107 for a member system development or region. A second selection box 109 provides for a selection of a development community from within the development that was selected in the first selection box 107. The selection of a target member system can also be made from a screen that provides the member systems in a hierarchical manner.

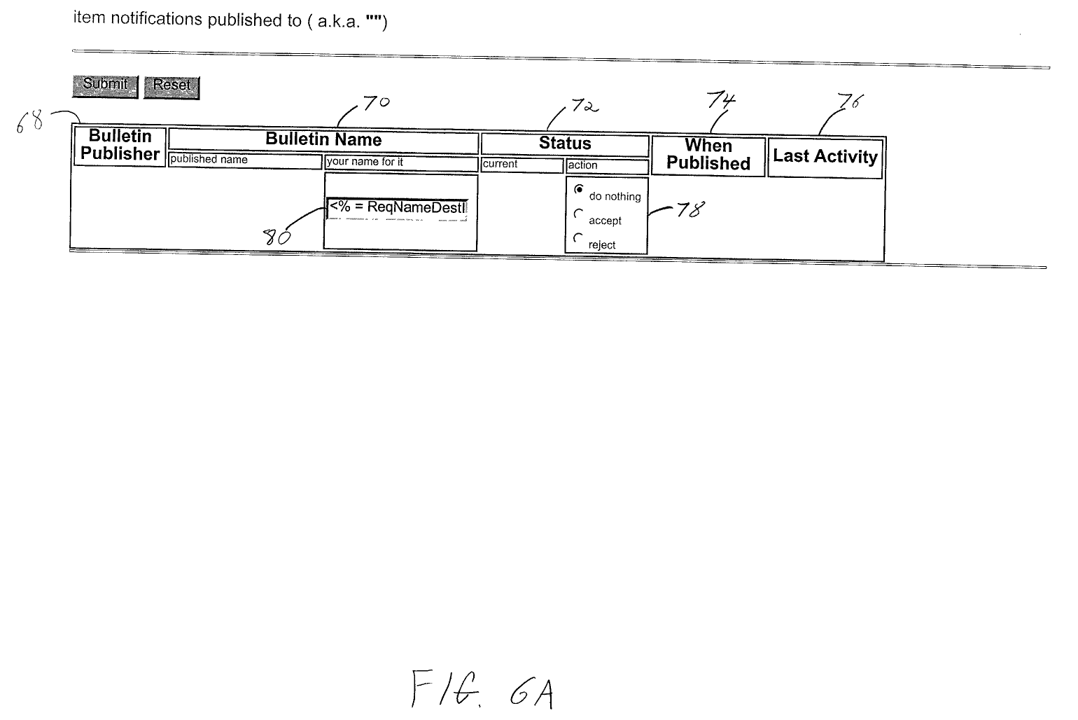

FIG. 5 illustrates a screen that is returned to a user in response to a request for viewing pending offers for an exchange contract. The screen of the CivicServer includes a bulletin direction column 52, a user at other end column 54, a bulletin item name column 56, and a new status column 62.

The bulletin direction column 52 identifies the direction to which the exchange contract offer has been sent. Exchange contract offers that are received for the particular user are considered in-bound exchange contract offers and exchange contract offers that are submitted by the particular user are considered out-bound exchange contract offers. The user at the other end column 54 identifies the user that either has sent the exchange contract offer or is the target of an exchange contract offer. The bulletin item name column 56 identifies both the external and internal names that were specified in the exchange contract offer as discussed with reference to FIG. 4A. The new status column 62 allows the user to select a new status for the exchange contract offer, either deleting an exchange contract that has been accepted by a second party, or rejecting an exchange contract offer that has been received for the particular user.

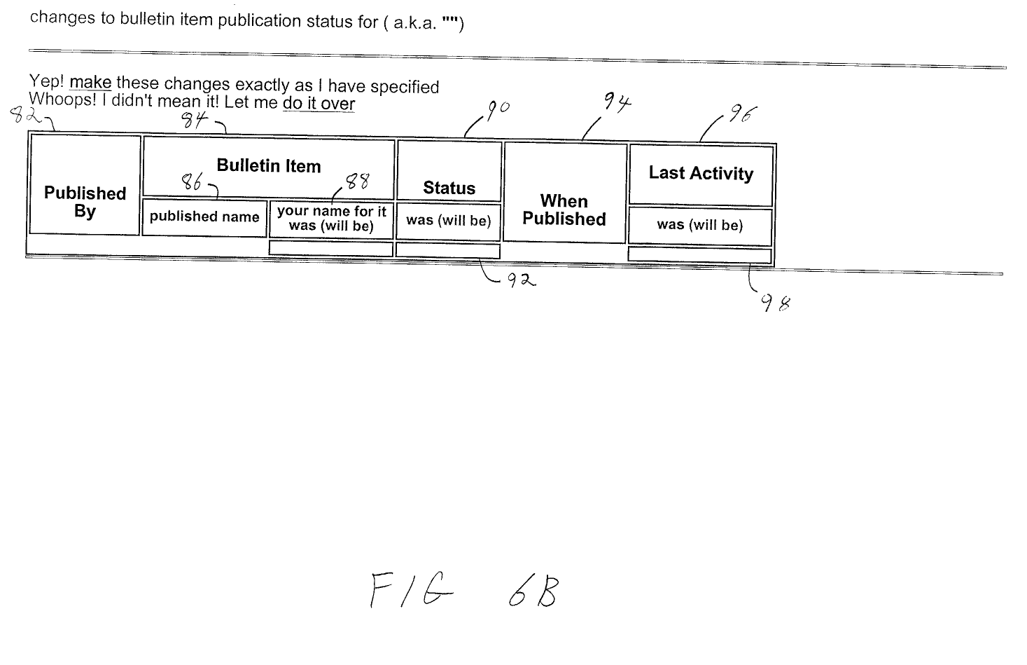

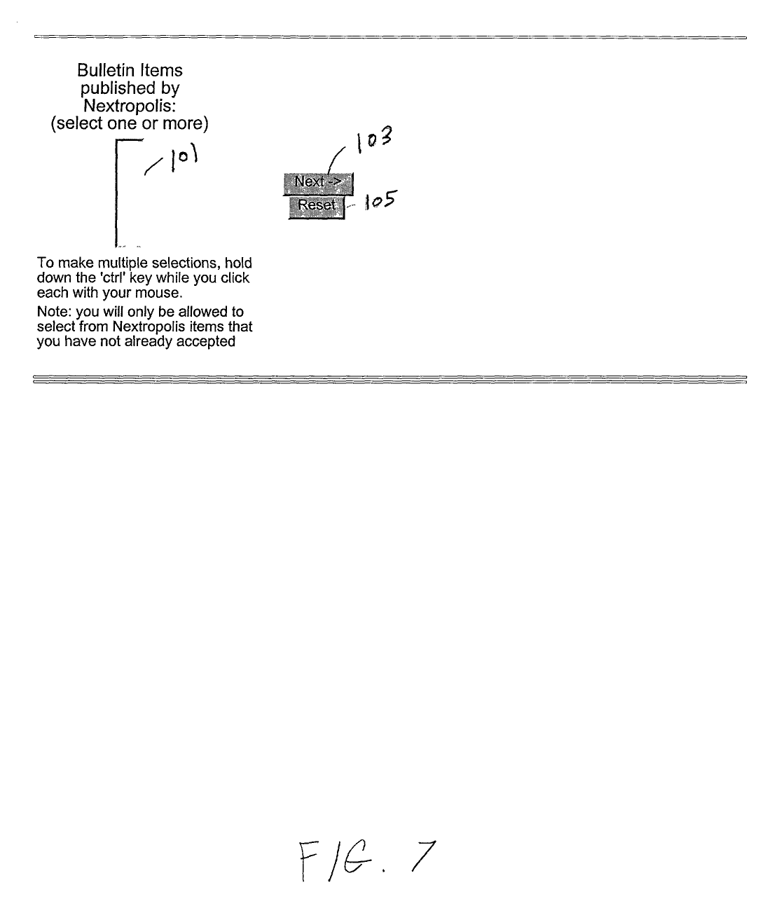

FIG. 6A illustrates an alternative arrangement for displaying information regarding exchange contract offers. The screen that is provided in FIG. 6A includes a bulletin publisher column 68, a bulletin name column 70, a status column 72, a when published column 74, and a last activity column 76. The bulletin publisher column 68 identifies the party that has sent the exchange contract offer. The bulletin name column identifies the object name that was provided to the public. The status column identifies the current status of the exchange contract offer and an action that may be taken by the user with regard to the particular exchange contract. The actions taken by the user can be selected from a selection box 78 which provides for a “do nothing” action, an “accept” action, and a “reject” action. The when published column 74 provides information as to the date that the exchange contract offer was sent or received. The last activity column 76 identifies the last action that was taken with regard to the particular exchange contract offer.

FIG. 6B illustrates an alternate screen that is provided in response to a user request for changing the status of an exchange contract offer. The screen includes a table with a published by column 82, a bulletin item column 84, a status column 90, a when published column 94, and a last activity column 96. The columns of FIG. 6B correspond to the same information as the columns of FIG. 6A. FIG. 6B further allows for greater freedom when the user modifies the information with regard to the exchange contract offer, such as by providing a box related to the last activity which allows the user to specify a future activity as well as a past activity.

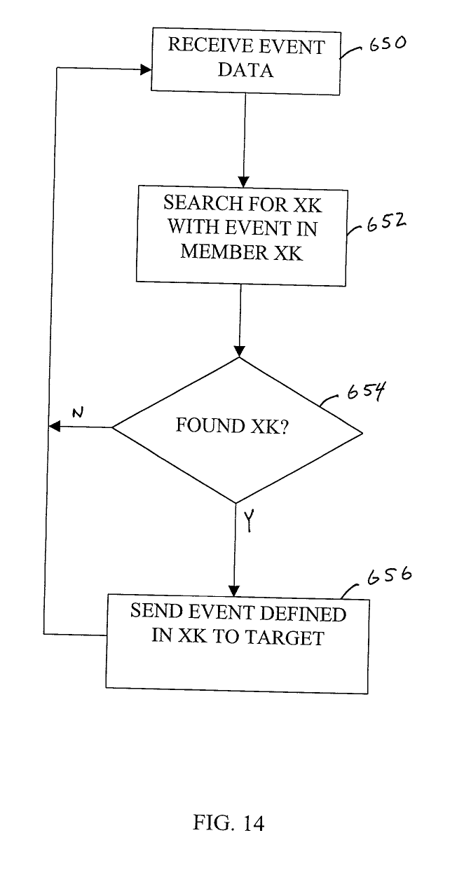

A user that has received an exchange contract offer such as those that can be browsed by the screens provided in FIGS. 6A and 6B can select to either accept or reject a particular offer. When an offer is accepted by the user, the exchange contract becomes an active exchange contract and is transmitted to the SynapServer which manages exchange contracts. The particular operation of the SynapServer is discussed below with reference to FIG. 14. From the user perspective, it is important to note that once an exchange contract has been accepted, the exchange contract becomes operative. Thereafter, an event or assertion transmitted from a member system causes data to be transmitted to the target member(s) specified in the exchange contract.

In one embodiment, member systems may indicate that they will always accept exchange contracts of particular categories. The CivicServer in this embodiment maintains common categories of objects or properties, such as, for example, a security category, or a medical emergency category. Identities of the members who have provided such indications of standing acceptances are maintained by the CivicServer in a standing acceptance list, along with the categories they identified. When a user creates an exchange contract, the user can optionally select one of the common categories within which to include the exchange contract. When the user submits the exchange contract for acceptances by the target members, the CivicServer searches for all members who have previously agreed to accept exchange contracts in the particular standard category and automatically creates exchange contracts for each of them, and transfers the exchange contract information to the SynapServer.

Exchange contracts can always be suspended or revoked in accordance with the user's wishes. An exchange contract can be suspended or revoked by any one of the parties to the particular exchange contract.

After exchange contracts are created, either party can put an exchange contract on hold. For example, if a member is going on vacation, the member may want to alter event notifications, and can advantageously put one or more exchange contracts on hold without invalidating the exchange contract.

To facilitate suspend or revoke functions, a screen of the SynapServer (not shown) offers a user with an exchange contract browse window by which the user may review all of his or her existing exchange contracts and select one. A user may then select a suspend option, whereupon the user is prompted to specify whether the suspension is indefinite or will end upon an entered date. If the user selects an indefinite suspension, then the SynapServer maintains a status variable for the selected exchange contract which indicates that the exchange contract is inactive. The SynapServer will maintain that status until the user again accesses this screen, and selects a make active option, whereupon the SynapServer again maintains the status of the exchange contract as active. If the user specifies a date upon which the suspension will expire, then the SynapServer posts a change status event comprising instruction which will execute on the specified date and cause the status of the suspended exchange contract to again become active. It will be appreciated that specifying a date to terminate a suspension effectively places the exchange contract on hold. If the user selects the revoke exchange contract option, the user is prompted with a message asking whether the user is sure that that step should be taken, and if the user confirms the revocation request, then the SynapServer will delete the selected exchange contract from the system.

Member systems are provided with a separate set of screens when creating exchange contracts with information consumers and information providers such as Nevada Power (or other utility supplier), e-tack, weather, etc. Information consumers, such as Nevada Power, may wish to read electric meters. Information providers, such as weather, may provide members with useful information. A member can advantageously provide a list of information consumers that it wants to make information available to, and thus at his sole discretion, create an exchange contract. Alternatively, the member can choose from a list of information providers to receive certain information.

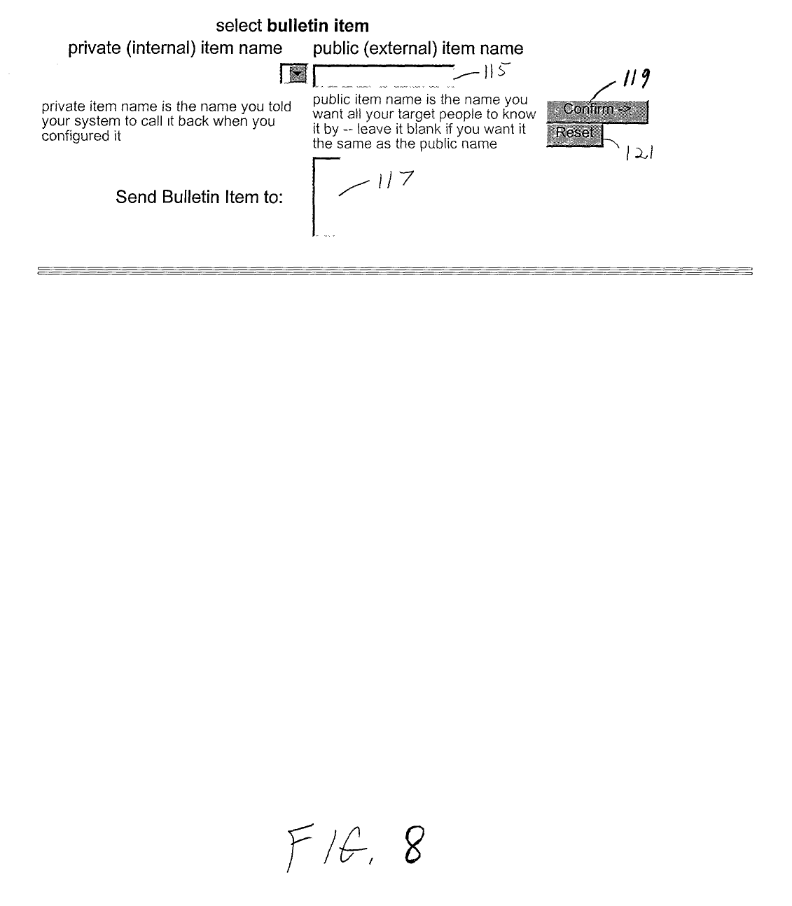

The CivicServer allows the user to create an exchange contract with an information provider or an information consumer. FIG. 7 illustrates a screen that is provided in response to a user request to create an exchange contract with an information provider. A list of available information 101 is provided on one side of the screen. Control boxes labeled “next” and “reset” 103, 105 are provided to the right of the information selection box 101. When a user selects data to receive from an information provider, the exchange contract is automatically created between the user and the information provider. The information provider does not have to agree to the exchange contract. Once information is selected from the list 101, and once the user has identified a target object or a property thereof, the member system starts receiving the data when it becomes available.

FIG. 8 illustrates an information provision screen. A user can use the screen to specify information to provide an information consumer. The screen includes a drop down selection box 114 to select the internal object and a text box 115 with which to assign a public name to that object. The screen further includes a selection box 117 to select an information consumer from a list of information consumers that may be interested in obtaining information from member systems. The member thereby specifies the object, provides a public name for the object, and then selects an information consumer such as an electrical utility that will receive data. When the user clicks on a confirm control button 119, the exchange contract is automatically created and data, when available, are sent to the information consumer from the particular object chosen.

Another aspect of the community network is its ability to upload messages and system information. Because member systems make available their associated properties, the community connector may access the property data and upload it into a database at the SynapServer which is specific to the member system. Currently, the uploads from the member systems take place every time the member system community connector starts, or every time the environment changes. Alternatively, the uploads can take place periodically in accordance with a predetermined parameter. Either way, the system advantageously maintains a database that is up to date regarding objects available at member systems. Because the SynapServer has available information regarding a member system's properties, a member may log in over the Internet, or other network, select one of those properties and propose an exchange contract to one or more members. Advantageously, the SnyapServer scans a list of all target members designated to receive data upon a particular assertion or event and ensures that no target member receives data multiple times for the same event or assertion.

Sample Scenarios

As an example, Nevada Power may be a consumer of information when trying to read the power meters of member homes. The power company may offer a discount to customers that allow for the remote reading. The company is thus allowed to read the individual meters regardless of the transport mechanism. In this particular example, the SynapServer is used to transmit data from one object of a member system to a second object of a member system. The power company may wish to receive the data from several properties of a power meter. A single exchange contract can be created to transmit selective properties to the power company.

An example of an information provider may be an Internet weather feed like the weather underground. The SynapServer takes the information from the service, such as the probability of precipitation and the projected temperature, and makes it available to the automation system at member homes. A member's home may respond to the message by, for example, changing the lawn watering schedule. Also, the local park authority or a golf course can change watering schedules.

Another example of an information provider is E-tack, which provides traffic information to most of the news services and to communication devices such as the palm pilot. If a home automation system receives traffic information and maintains data regarding the route that the member takes to work, the member can manage time better. For example, with this information, the home automation system can activate a wake-up alarm early and suggest an alternate route.

A system that allows for selective messaging between member systems can also be used to provide services such as “load shaping” and “load clipping” functions for local power companies. The load shaping function allows participating member systems to alter utilization to smooth out load on the power grid. In load shaping, participating member systems could smooth out projected power load in advance by, for example, turning on air conditioners early in the morning of a hot day, permitting a shut down of air conditioners during a peak consumption period later on in the day with minimal discomfort to the end users. Load clipping is an interactive function initiated by a power company to reduce the current load on the power grid. In the present embodiment, member systems that agree to receive the load clipping messages, in response to a load clipping request, may shut off certain high load devices (such as air conditioners) in order to instantaneously reduce the load a given community places on the power grid.

III. System Architecture

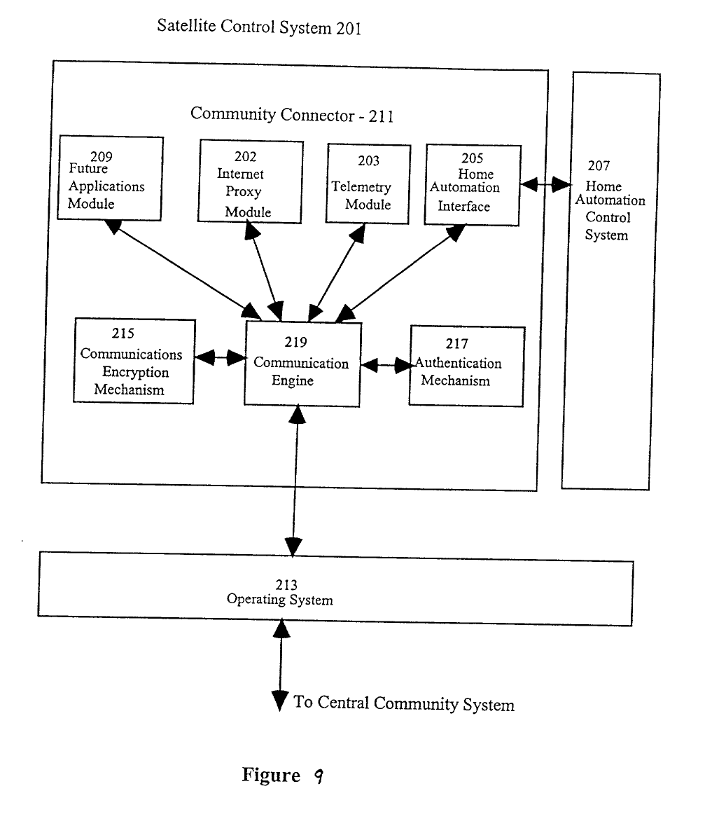

FIG. 9 illustrates the basic elements of a Satellite Control System 201 in accordance with one embodiment of the present invention. Three subsystems make up each member system 201, a home automation control system 204, a community connector 211, and an operating system 213. Home automation control systems such as Cyber House and Home Director Pro are commercially available. For example, Home Director Pro from IBM permits user to control lights, heating and temperature. The operating system 213 is any conventional operating system, and is typically specific to the hardware environment involved. Examples of commonly available operating systems are Windows 95, Windows NT, Windows CE, DOS, OS/2, and LINUX. The present invention enhances such systems with a unique Community Connector 211.

The Community Connector 211, in one embodiment, includes a Home Automation Interface 205, a Telemetry Module 203, an Internet Proxy Module 202, and a Future Applications Module 209. A Communication Engine 219 communicates with the other modular servers, and utilizes a Communications Encryption Module 215 and an Authentication Module 217 to establish a secure, authenticated, link to the Central Community System 301. In one embodiment, the security is based on SSL, as is known in the field.

The Home Automation Interface 205 facilitates the exchange of data between the SynapServer and the Home Automation Control System 207. The Home Automation Control System 207 performs relevant tasks for the home/office environment. In one embodiment, the Home Automation Interface 205 receives application code executable by the Home Automation Control System 207. More particularly, the Home Automation Interface 205, in addition to communicating with the Home Automation Control System 207, can send and receive control programs or applets in the form of application code that can be executed by the Home Automation Control System 207. Thus, in addition to event data which may trigger a response by the target system, program or applet data may be received which could, for example, change an algorithm used by the target system thereby altering its response to event data.

The Telemetry Module 203 monitors the status of the Satellite Control System 201. The telemetry module tracks information such as available disk space, free memory, temperature, and other resources, so as to maintain the Satellite Control System 201 in an optimal working order. The Telemetry Module 203 may also prompt for the execution of system diagnostics on a periodic or predetermined basis. Telemetry includes physical aspects, power conditioning, heat, as well as system metrics, available disk space and memory, etc. Collecting telemetry data allows for the monitoring of the status of a member system or object.

In one embodiment, Internet-based protocols may be used to communicate between member systems or objects and the SynapServer. Client programs at member homes or object locations use standard Web protocols, which allow for using various transmission media such as modems, cables, or other devices that support Internet access. The standard protocols include certificates, such as those used by a bank to allow customers to do home banking.

The Internet Proxy Module 202 may comprise, for example, a HTTP, a HTTP/S, and/or an FTP Proxy Server which serves as a hub for Internet communication for multiple PC's located in the environment at the Satellite Control System 201. Via the Internet Proxy Module 202, Internet services can be provided to a plurality of computers via the community network's secure, authenticated, communications channel with no additional IP addresses required. Upstream application modules, located in the SynapServer, can provide caching and content filtering services. By providing Internet service through the proxy module via the SynapServer, additional security and/or parental control may be exercised. The content filters, may reside at the central server instead of the local user's computer, advantageously decreasing the likelihood that they would be removed or disabled.

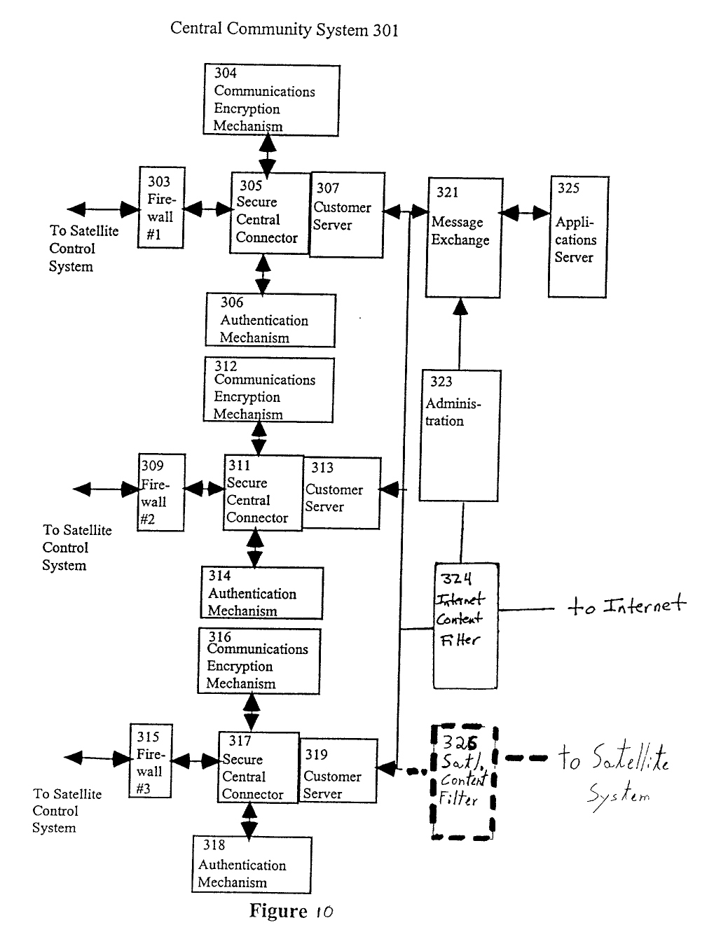

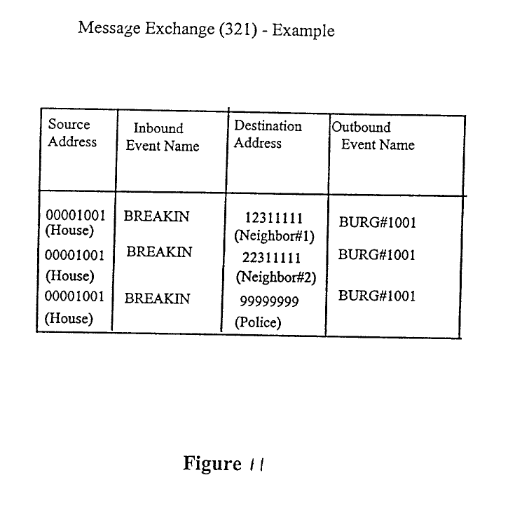

An Internet content filter 324 (FIG. 10) may provide caching and content filtering services for the Internet proxy module 202, as described above. A designated user specifies, via the administration module 323, which Internet content is allowed or disallowed for a particular Internet proxy module 202. A satellite content filter 326 may provide content filtering services for satellite data.

Each member system or object is assigned a Global User ID (GUID). The GUID is a unique identifier that associates a member system with a corresponding information database and identifies member systems or objects in exchange contracts. In addition to a GUID, the SynapServer stores an e-mail address as one of the member system properties. The GUID is used in the exchange contracts to identify the member systems thereby providing a greater level of confidentiality because only the SynapServer can access the detailed member identification data associated with the GUID.

The exchange contract contains both the internal object identifier and an external identifier. As one example, when a home alarm is triggered, an event called “user 911” may be generated in one version of Cyber House. A member adds a description to the event, making it more meaningful to a target member. If the exchange contract is accepted, an internal event on the destination side must also be defined. Part of the discretion that the community network affords is in the fact that one member does not know which of another member's internal objects generated an event, it only knows the external description, and by the same token, the sending member cannot directly learn precisely how the target member responds to the event. Thus, there is a mapping that occurs on either end of the exchange contract.

Due to the modular nature of the software elements, which are merely plugged into the Communication Engine 219, these elements can be replaced or updated independently in the future. Furthermore, any future application element 209 can be added without interfering with the other elements.

FIG. 10 shows one arrangement of the elements in the central server 300. Messages from the Satellite Control System 201 arrive to a Firewall 303 which protects the SynapServer, as well understood in the art. The data is communicated to a Customer Server 307 by a Secure Central Connector 305. The Secure Central Connector 305 decodes and authenticates the message and forwards it to the Message Exchange 321 via a Customer Server 307. The Customer Server 307 can serve multiple customers. To accommodate increasing number of customers, the system may be scaled by replicating the modular group comprising the Firewall 303, the Secure Central Connector 305, the Communications Encryption 304, the Authentication module 306, and the Customer Server 307.

The message exchange 321 is an event based message switching system that, based on source address and inbound message content, generates one or more outbound messages with predetermined content and destinations. The outbound messages are routed back through the system taking a path similar to the inbound messages, i.e. a secure, authenticated communication path.

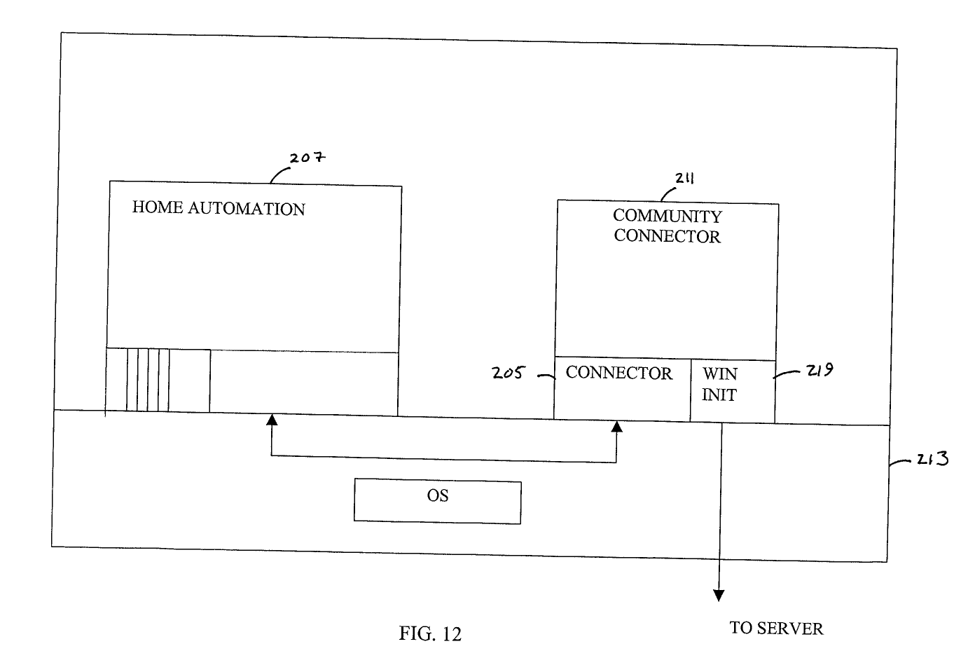

Message Exchange 321 is essentially a table look-up system which is shown in FIG. 11. A simple example event shown in FIG. 12 illustrates how the event message is handled by the message exchange 321. In this example, an event “BREAK-IN” occurs at House #1001 with a source address “00001001”. Upon receiving the inbound message, the Message Exchange generates outbound messages with predetermined destinations and content. Those destinations are Neighbor #1 with address “12311111”, Neighbor #2 “22311111”, and Police Station “99999999”. The content of message reads “BURG# 1001”.

The Applications Server 325 provides event information to Message Exchange 321. For example, alerted by an approaching weather front transmitted from the Internet, Applications Server 325 provides a message to Message Exchange 321 to be distributed to the member systems and objects that agreed to receive the information. Another example may be a sudden fluctuation in temperature which alerts Applications Server 325 to send a message to Electric Power Company to make an appropriate adjustment in power supply of member systems and objects that agreed to receive such adjustment message. The message exchange database is continuously updated and managed by Administration 323.

Similarly, if a high pressure region is approaching, a warning delivered by, for example, the Internet, satellite, or radio, can provide an alert to the application server 325 which may be monitored by the electric power company in the area. This allows the electric power company to automatically respond by preparing for a surge in power consumption. As another example, where there are frequent needs for emergency prescriptions at night, the application server 325 may access a database of doctors, patients, and their prescriptions, and contact a pharmacy open for delivery service at the hour at which the prescription is requested. Such database may be continually updated and maintained by the database administration 323.

FIG. 12 illustrates another embodiment of the software modules that are associated with a member system of the present invention. The software modules include a home automation module 207, a community connector module 211, a home automation interface 205, and a communication engine 219. The home automation module 207 and the community connector module 211 are configured to work with the operating system 213 which is used by the particular member system or object. The community connector 211 communicates with the home automation system 207 by a home automation interface 205 that is selected to be compatible with the particular home automation system.

In one embodiment, the controls for interfacing with the home automation system 207 are provided by the manufacturer of the home automation system. Such controls may be OCX controls that can be easily integrated into a Visual Basic application to provide an interface between the two modules. In another embodiment, the home automation interface 205 may be a DLL that is provided by the home automation system manufacturer to interface with the home automation system 207.

One of the home automation systems available today, Cyber House, has internal modules that communicate with the NAPCO alarm panel, thermostats, home theater systems, and the community connector. The community connector OCX controls allow the community connector to communicate with Cyber House. Cyber House also provides an API that includes a way of accepting messages. On system startup, the connector OCX, via TCP/IP, sets up a connection with the home automation module 207, which provides the community connector 211 with a list of devices associated with assertions or events. The device data are communicated to the SynapServer to update the particular member database.

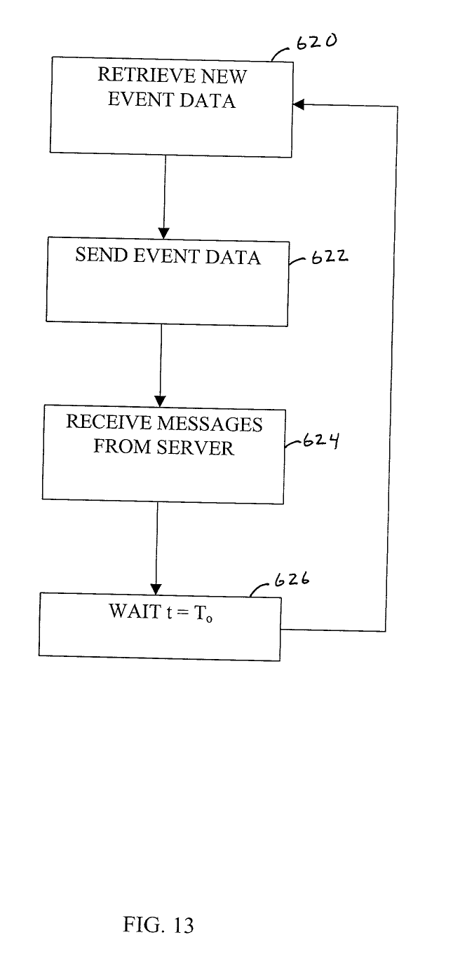

FIG. 13 illustrates the steps performed in one embodiment of the present invention by a member system or object in delivering data to and receiving data from, the central server. In a first step 620, the member system receives or is otherwise notified of new property data from the home automation system via the home automation interface. In a next step 622, the data is then transmitted to the control server by using the communication engine possibly in conjunction with transmission protocols provided by the operating system. The transmission preferably employs common Internet protocols such that data can be transmitted over any lines that are commonly used for Internet services.

In a step 624, the member system or object, after sending the data to the central server, receives the data from the central server that are addressed to the member system. The member system then processes the received data, if any. Once the data are processed, the member system or object, in a further step 626, waits for a predetermined time period before re-initiating the process, by retrieving new data in the step 620.

Thus, a member system continuously cycles through a series of steps in transmitting data, receiving data, and processing data. The use of continuous cycling, or polling, provides for a predetermined latency between the generation of an event by a first member system or object and the reception of data in response to the event by a second member system or object. For example, if the cycle outlined above repeats every ten seconds, the maximum latency between an event and the reception of a message in response to the event is 20 seconds, which includes a maximum time of 10 seconds to transmit new event data, and the maximum time of 10 seconds to receive the new event data at the target system. In another embodiment, the member systems are connected to the central server by a communication link that is continuously available for the transmission of messages. Using a continuous link, the member system or object may receive data in less than one second after a corresponding event occurs.

In embodiments using polling, the SynapServer can adjust the polling interval, by changing the value of a polling interval value, for example, when the home automation module 207 next connects to the community connector 211. If congestion increases, the system can advantageously cause home systems or objects to decrease their polling rates to any rate necessary to relieve the congestion.

FIG. 14 illustrates steps performed by the SynapServer in processing data received from member systems and objects and generating response messages. In a first step 650, the SynapServer receives event data from a member system or an object. When new data is received, the SynapServer, in a step 652, searches for an exchange contract corresponding both to the event data and the source system identification. If such an exchange contract is found in a step 654, the SynapServer, in a next step 656, sends data to the target member(s) identified in the exchange contract. If a fitting exchange contract is not found in the step 654, the SynapServer returns to the step 650. As may be appreciated, the operations undertaken by the SynapServer may be executed in parallel so as to continuously receive data and continuously process data.

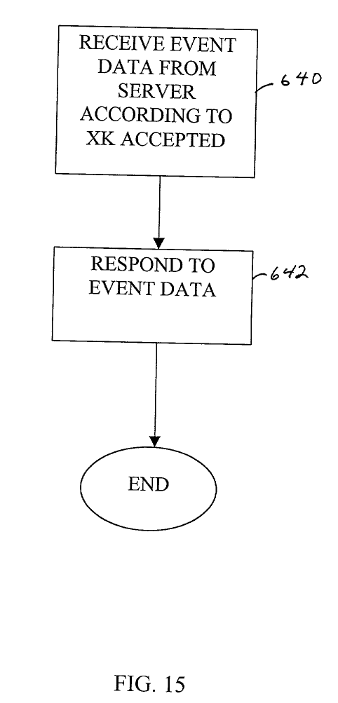

FIG. 15 illustrates steps performed in one embodiment of the present invention to receive and respond to event data. In a step 640, a target member system or object receives assertion or event data from the SynapServer in accordance with an accepted exchange contract. In a next step 642, the local system of the target member system or object parses the event data and responds to the event data in accordance with steps the operator of the member system or object has established to be taken when the local system recognizes the particular received event.

The system is presently implemented by using sequel server seven, although one of ordinary skill in the art would appreciate that any database can be used. Internet-based data, such as a web page, that may be used with are embodiment of the CivicServer maybe dynamically generated from the database by submitting a query based on exchange contract data and member identification data. The records may be translated into HTML, and displayed as Web pages.

The above described system is only one of many embodiments. The system can be modified to suit the community which it is intended to serve. It will be apparent to those skilled in the art that there are many alternatives related to the embodiments of the invention described herein which may be used without departing from the spirit and scope of the invention. The scope of the invention is intended to be defined by the claims that follow.

What is claimed is:

1. A community communication system comprising:
a central computer server;
a plurality of member computer systems in communication with the central server; and
a data transfer module adapted to execute an automated communication, based upon a negotiation between at least two of said plurality of member systems, between at least one of said plurality of member systems and at least one other of said plurality of member systems, the at least one other of said plurality of member systems configured to execute a predefined response in response to the automated communication.

2. The community communication system of claim 1, wherein said data transfer module arbitrates data transfers between said plurality of member computer systems based upon a prespecified list of data transfer types enabled for receipt by respective member computer systems.

3. A method of communicating between member computer systems that are connected to a common computer network, comprising:
providing a data transfer module which arbitrates data transfers authorized by respective member computer systems;
enabling through negotiation between member computer systems at least one data transfer type from a first member system to a second member system which the second member system has authorized for receipt,
monitoring with said data transfer module data streams from member systems which communicates events from member systems;
if said data stream is enabled for communication to another member system, routing said data stream to said another member system;
at said another member system, responding to said data stream in a predefined manner in accordance with said negotiation.
wherein said action comprises sending via said message module a message to another member system on the network.

4. The method of claim 3, wherein said monitoring is accomplished over a satellite communication link.

5. The method of claim 3, wherein the step of defining comprises:
providing an offer for an exchange contract by a first member computer system, the exchange contract disclosing a data stream type desired for delivery to a second member computer system in response to an event on said first member computer system;
accepting the exchange contract with said second member computer system; and
enabling at the data transfer module at least one data transfer type authorized for delivery to said second member computer system in response to an event on said first member computer system.

6. The method of claim 3 wherein said providing an offer and said accepting is accomplished via an Internet server.

7. The method of claim 3, wherein said providing an offer and said accepting is accomplished via a satellite communication system.

8. The method of claim 3 wherein said providing an offer and said accepting is accomplished via a radio communication system.

9. The method of claim 3 further comprising the step of notifying said second member computer system of the pending exchange contract offer by sending an electronic mail message to said second member computer system.

10. The method of claim 3, wherein said enabling is executed at a central computer system.

11. A message distribution system comprising:
a plurality of member computer systems;
a message server in communication with the member systems;
a distribution table for the message server, the distribution table having message type definitions and links which indicate enabled message types accepted by respective ones of the plurality of member systems; and
a negotiation module which executes requests and responses from member systems regarding the acceptance of message types, and stores the results in said distribution table.

12. The message distribution system of claim 11, wherein the negotiation module forms exchange contracts between members, the exchange contracts indicating message types enabled for acceptance between at least two member computer systems.

13. The message distribution system of claim 11, wherein the communication between member systems and the message server employs SSL security protocols and certificates.

14. The message distribution system of claim 11, wherein Internet communication protocols are used to communicate between member systems and the message server.

15. The message distribution system of claim 11, wherein the member systems employ a polling mechanism to transmit event information to the message server.

16. The message distribution system of claim 11, further comprising an Internet proxy module to allow devices at the member computer system to communicate with the Internet.

17. The message distribution system of claim 11, wherein the member systems employ real-time event driven communication protocols to transmit event information to the message server.

18. The message distribution system of claim 17, wherein the negotiation module maintains a source system ID, an event name, a public name, and a private event name.

19. The message distribution system of claim 17, wherein an enabled message can be suspended such that no messages are transmitted in response to the event defined for the message while the message is suspended.

20. The message distribution system of claim 17, wherein requests can be extended to all member systems by a provider of information.

21. The message distribution system of claim 17, wherein the responses to defined requests can be pre-authorized by a member system.

22. A method for facilitating the exchange of data between computer systems in a computer network, comprising:
sending a data reception offer from a source system to a central server, to be sent to a target system, the offer including at least a data identifier and an identifier of a target system;
providing information regarding the offer to the target system identified in said data reception offer; and
if the target system accepts the offer, enabling data identifiers of the type defined in the offer to be accepted by the target system.

23. The method of claim 22, further comprising the step of sending data to the target system in accordance with a data reception offer that the target system has previously accepted.

24. The method of claim 22, wherein the data is generated in response to a predetermined event.
